(19) United States
(12) Patent Application Publication
(10) Pub. No.: US 2022/0376328 A1
(43) Pub. Date: Nov. 24, 2022

(54) SECONDARY BATTERY COOLING STRUCTURE

(71) Applicant: HONDA MOTOR CO., LTD., Tokyo (JP)

(72) Inventor: Atsushi Sakurai, Wako-shi (JP)

(21) Appl. No.: 17/743,489

(22) Filed: May 13, 2022

(30) Foreign Application Priority Data
May 24, 2021 (JP) 2021-086633

(51) Int. Cl. H01M 10/6568; H01M 10/613; H01M 10/6556

(52) U.S. Cl. CPC H01M 10/6568; H01M 10/613; H01M 10/6556

(57) ABSTRACT

A secondary battery cooling structure according to an embodiment of the present invention includes: a circulation circuit that circulates a fluid; an exterior body having a connection port that communicates with the circulation circuit; and an electrode laminate body having a flat plate shape, accommodated in the exterior body, and formed to be sealed by a resin film, wherein the exterior body and the electrode laminate body are provided to be spaced apart from each other, and the fluid flows through a space between the exterior body and the electrode laminate body.

### CROSS-REFERENCE TO RELATED APPLICATION

Priority is claimed on Japanese Patent Application No. 2021-086633, filed on May 24, 2021, the contents of which are incorporated herein by reference.

### BACKGROUND

### Field of the Invention

The present invention relates to a secondary battery cooling structure.

### Background

In recent years, electric vehicles using electricity as a power source and hybrid vehicles that travel by combining an engine and a motor have attracted attention, and various battery modules mounted on the vehicles have been proposed.

For example, Japanese Unexamined Patent Application, First Publication No. 2007-273149 discloses a battery module (secondary battery) that includes a battery element exterior material constituted of a laminate film having a structure in which two or more resin film layers are laminated.

The battery module described in Japanese Unexamined Patent Application, First Publication No. 2007-273149 has an exterior body storing a resin layer having gas permeability and discharges a gas generated in a space through the resin layer to the outside via a safety valve mechanism.

### SUMMARY

In a cooling structure of a battery module described in Japanese Unexamined Patent Application, First Publication No. 2007-273149, the gas may remain at a corner part in the exterior body or between the resin layer and an inner wall in the exterior body, and removal of the gas may not be sufficient. When the removal of the gas is not sufficient, the flow of a fluid such as a refrigerant may be hampered, and it may take time to cool the battery module.

An aspect of the present invention is intended to provide a secondary battery cooling structure capable of quickly cooling a secondary battery while sufficiently removing a gas generated in an inside of the secondary battery.

A secondary battery cooling structure according to a first aspect of the present invention includes: a circulation circuit that circulates a fluid; an exterior body having a connection port that communicates with the circulation circuit; and an electrode laminate body having a flat plate shape, accommodated in the exterior body, and formed to be sealed by a resin film, wherein the exterior body and the electrode laminate body are provided to be spaced apart from each other, and the fluid flows through a space between the exterior body and the electrode laminate body.

A second aspect is the secondary battery cooling structure according to the first aspect, wherein the connection port may include a first connection port and a second connection port, the exterior body may have a substantially square shape in plan view formed of a pair of first exterior body sides and a pair of second exterior body sides orthogonal to the first exterior body sides, the first connection port and the second connection port may be provided on the first exterior body sides, the electrode laminate body may be formed of a first electrode laminate body side that faces the pair of first exterior body sides and a second electrode laminate body side that faces the pair of second exterior body sides in plan view, and have a substantially square shape that is smaller than the exterior body, a first cooling flow passage may be provided between the first exterior body side and the first electrode laminate body side, a second cooling flow passage may be provided between the second exterior body side and the second electrode laminate body side, and a cross-sectional area of the first cooling flow passage may be smaller than a cross-sectional area of the second cooling flow passage.

A third aspect is the secondary battery cooling structure according to the second aspect, wherein each of the first connection port and the second connection port may be provided in a region where the first cooling flow passage and the second cooling flow passage cross with each other.

A fourth aspect is the secondary battery cooling structure according to the second aspect, wherein the first connection port and the second connection port may be provided at a position that overlaps the first cooling flow passage.

According to the first aspect described above, the fluid flows through the space between the exterior body and the electrode laminate body. Therefore, it is possible to provide a secondary battery cooling structure capable of quickly cooling the secondary battery while sufficiently removing the gas generated in the inside of the secondary battery.

In the second aspect described above, the cross-sectional area of the first cooling flow passage is smaller than the cross-sectional area of the second cooling flow passage. Therefore, by increasing a flow speed of a fluid that flows through the first cooling flow passage and decreasing a flow speed of a fluid that flows through the second cooling flow passage, it is possible to enhance the discharge property of the gas generated in the fluid while equalizing the flow amount distribution of the fluid.

In the third aspect described above, each of the first connection port and the second connection port is provided in a region where the first cooling flow passage and the second cooling flow passage cross with each other. Therefore, it is possible to further efficiently remove the gas remaining in the region where the first cooling flow passage and the second cooling flow passage cross with each other by using the flow speed of the fluid that flows through the first cooling flow passage.

In the fourth aspect described above, the first connection port and the second connection port are provided at a position that overlaps the first cooling flow passage. Therefore, it is possible to further increase the flow speed of the fluid that flows through the first cooling flow passage. Accordingly, it is possible to further efficiently remove the gas remaining in the region where the first cooling flow passage and the second cooling flow passage cross with each other by using the flow speed of the fluid that flows through the first cooling flow passage.

### BRIEF DESCRIPTION OF THE DRAWINGS

FIG. 1 is a flow view schematically showing a secondary battery cooling structure according to an embodiment of the present invention.

FIG. 2 is a plan view schematically showing a secondary battery included in the secondary battery cooling structure according to the embodiment of the present invention.

FIG. 3 is a III-IIIcross-sectional view of FIG. 2.

FIG. 4 is a IV-IV cross-sectional view of FIG. 2.

FIG. 5 is a V-V cross-sectional view of FIG. 2.

### DESCRIPTION OF EMBODIMENTS

Hereinafter, embodiments of the present invention will be described with reference to the drawings. In the drawings used in the following description, a feature portion may be enlarged for ease of understanding of the feature, and the shape, the dimensional ratio, and the like of each configuration element are not limited to those shown in the drawings.

### First Embodiment

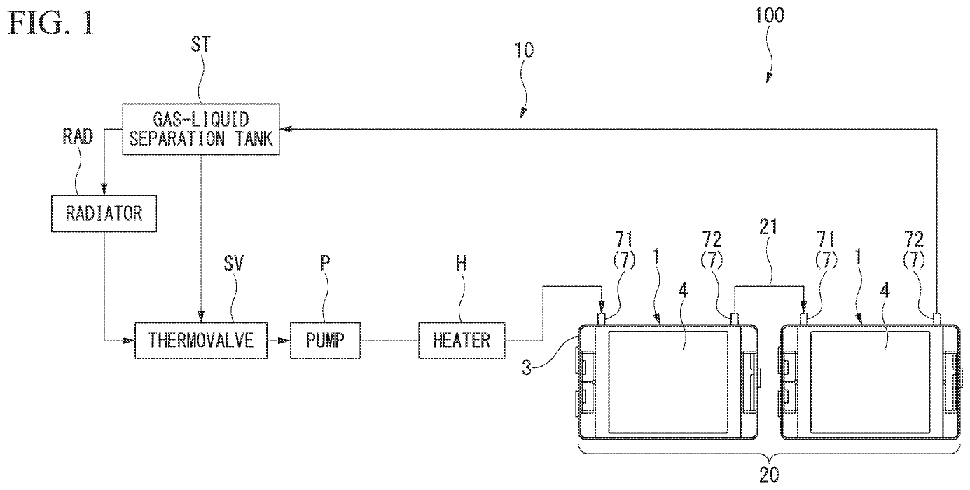

FIG. 1 is a flow view schematically showing a cooling structure 100 of a secondary battery 1 according to an embodiment of the present invention.

As shown in FIG. 1, the cooling structure 100 of the secondary battery 1 includes a circulation circuit 10 that circulates a fluid and a power storage module pack 20 that includes a plurality of secondary batteries 1.

A fluid that is a cooling solvent (refrigerant) circulates in the circulation circuit 10 and the power storage module pack 20. A gas or a liquid can be used as the fluid. For example, the fluid is a liquid having an insulation property such as a fluorinated inert liquid. Since the fluid is a liquid having an insulation property, it is possible to directly cool an internal bus bar 14 described later, and it is possible to enhance the cooling performance.

The circulation circuit 10 includes a gas-liquid separation tank ST, a radiator RAD, a thermovalve SV, a pump P, and a heater H. In the present embodiment, the circulation circuit 10 includes the heater H, but may not include the heater H.

In the following description, a direction in which the liquid flows out of the power storage module pack 20 is an “upstream side”, and a direction in which the fluid flows into the power storage module pack 20 is a “downstream side” using the power storage module pack 20 as a reference when the fluid flows through the circulation circuit 10.

The gas-liquid separation tank ST separates a gas and a liquid of a fluid that flows from the power storage module pack 20. The liquid separated by the gas-liquid separation tank ST circulates as a fluid in a downstream side of the gas-liquid separation tank ST.

An upstream side of the gas-liquid separation tank ST is connected to the power storage module pack 20. A downstream side of the gas-liquid separation tank ST is connected to an upstream side of the radiator RAD and an upstream side of the thermovalve SV.

The radiator RAD exchanges heat between the fluid and the outside air. A downstream side of the radiator RAD is connected to an upstream side of the thermovalve SV.

The thermovalve SV is a three-way valve that is switched by the temperature of the fluid. A downstream side of the thermovalve SV is connected to an upstream side of the pump P.

The pump P supplies the fluid to the circulation circuit 10 through the power storage module pack 20 in response to a request output by the power storage module pack 20. A downstream side of the pump P is connected to an upstream side of the heater H.

The heater H has a function of adjusting the temperature of the fluid. A downstream side of the heater H is connected to the power storage module pack 20. When the heater H is not provided, the downstream side of the pump P is connected to the power storage module pack 20.

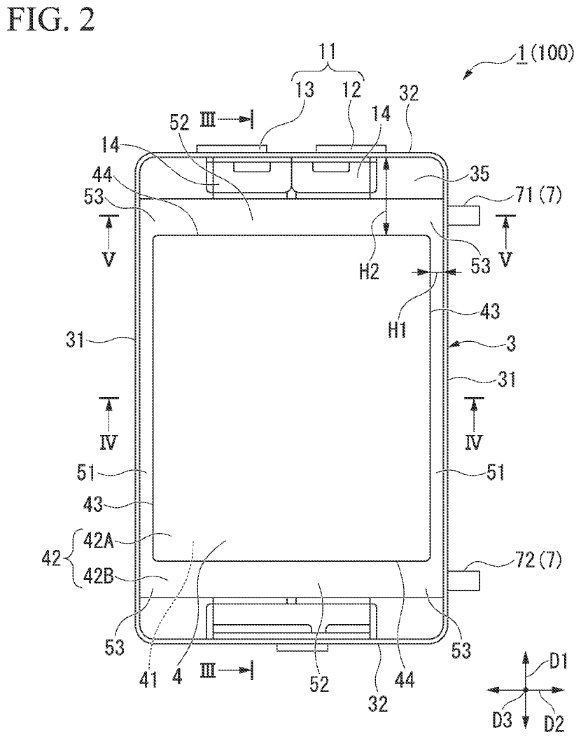

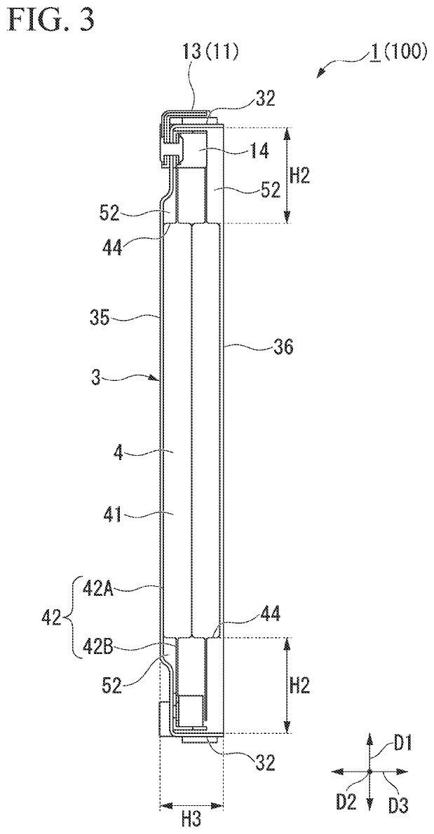

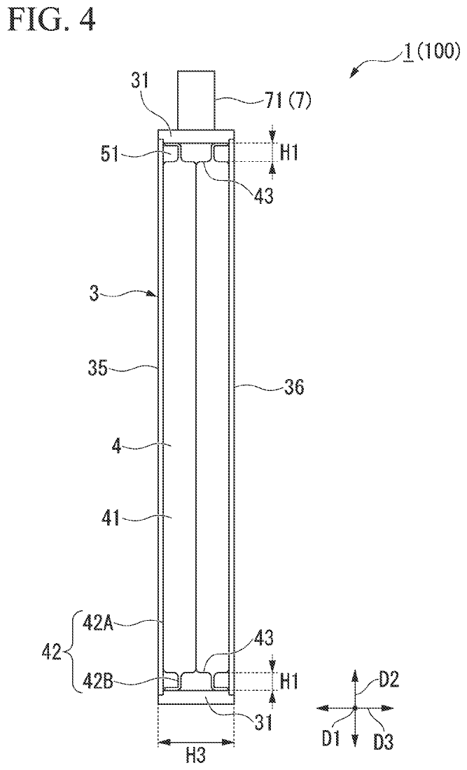

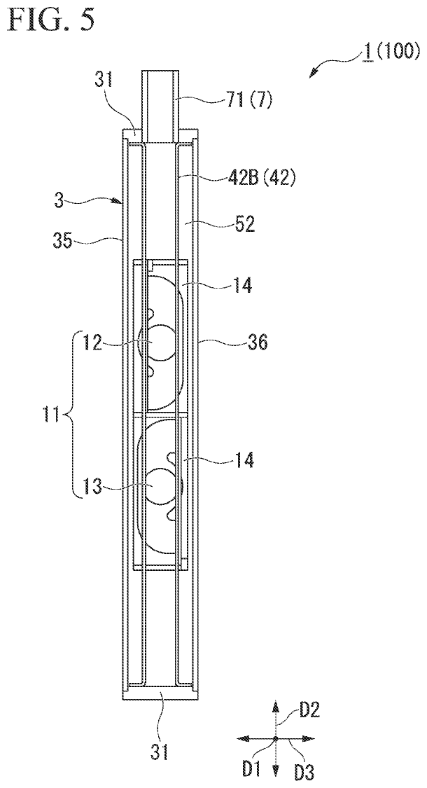

FIG. 2 is a plan view schematically showing the secondary battery 1 included in the cooling structure 100 of the secondary battery 1 according to the embodiment of the present invention. FIG. 3 is a cross-sectional view of FIG. 2. FIG. 4 is a IV-IV cross-sectional view of FIG. 2. FIG. 5 is a V-V cross-sectional view of FIG. 2.

The secondary battery 1 is a plate-shaped member having a rectangular shape in plan view. The secondary battery 1 is, for example, a pouch-type lithium-ion secondary battery.

In FIG. 2 to FIG. 5, a D1 direction indicates a longitudinal direction of the secondary battery 1 in plan view. A D2 direction indicates a width direction of the secondary battery 1 in plan view. A D3 direction is a depth direction of the secondary battery 1 in plan view.

As shown in FIG. 2 to FIG. 5, the secondary battery 1 includes an exterior body 3, an electrode laminate body 4 having a flat plate shape accommodated in the exterior body 3, and an external terminal 11.

The exterior body 3 forms an outer wall of the secondary battery 1. The exterior body 3 has a substantially square shape formed of a side wall 35 (refer to FIG. 3 to FIG. 5), a pair of first exterior body sides 31, and a pair of second exterior body sides 32. The exterior body 3 has a connection port 7 in communication with the circulation circuit 10.

The side wall 35 is a plate-shaped member having a rectangular shape in plan view. The side wall 35 has a longitudinal direction in the D1 direction in plan view.

The first exterior body side 31 stands from the side wall 35 in plan view (when seen from the D3 direction).

The first exterior body side 31 is along the D1 direction, which is a longitudinal direction of the secondary battery 1.

The second exterior body side 32 stands from the side wall 35 in the same direction as the first exterior body side 31 and is orthogonal to the first exterior body side 31.

A round chamfering is applied to four corners of the exterior body 3 formed of the first exterior body side 31 and the second exterior body side 32.

The exterior body 3 is sealed by a lid body 36 (refer to FIG. 3 to FIG. 5) from the opposite side of the side wall in the D3 direction such that the fluid filled in the inside of the exterior body 3 is not leaked. In FIG. 2, the lid body 36 is omitted for ease of explanation.

The electrode laminate body 4 is formed of a first electrode laminate body side 43 that faces the pair of first exterior body sides 31 and a second electrode laminate body side 44 that faces the pair of second exterior body sides 32 in plan view, and has a substantially square shape that is smaller than the exterior body 3. The electrode laminate body 4 is a plate-shaped member having a rectangular shape in plan view.

The electrode laminate body 4 is formed by sealing an electrode body 41 by a resin film 42.

The electrode body 41 is constituted of an electrolyte layer disposed on a positive electrode, a negative electrode, and between the positive electrode and the negative electrode. The center of the electrode body 41 is located at the center of the resin film 42 in plan view.

The resin film 42 sandwiches the electrode body 41 toward the inside of the D3 direction. The resin film 42 is formed of an insulating resin (which does not contain metal) having gas permeability. In the following description, a portion of the resin film 42 that sandwiches the electrode body 41 is referred to as a resin film main body portion 42A, and a portion of the resin film 42 that surrounds the resin film main body portion 42A when seen from the D1 direction is referred to as a resin film peripheral portion 42B.

The resin film main body portion 42A is provided without a gap between the side wall 35 and the lid body 36 as shown in FIG. 3 and FIG. 4. The outside surface of the resin film main body portion 42A forms the first electrode laminate body side 43 along the D1 direction and the second electrode laminate body side 44 along the D2 direction.

The resin film peripheral portion 42B overlaps with the electrode body 41 in the D3 direction without sandwiching the electrode body 41. The thickness in the D3 direction of the resin film peripheral portion 42B is thinner than the thickness in the D3 direction of the resin film main body portion 42A. As shown in FIG. 3 to FIG. 5, the exterior body 3 and the electrode laminate body 4 are provided to be spaced apart from each other at a position corresponding to the resin film peripheral portion 42B. A space provided between the resin film peripheral portion 42B and the side wall 35 and between the resin film peripheral portion 42B and the lid body 36 is filled with a fluid.

A first cooling flow passage 51 is provided between the first exterior body side 31 and the first electrode laminate body side 43. Specifically, the first cooling flow passage 51 is a portion surrounded by the first exterior body side 31, the first electrode laminate body side 43, the side wall 35, and the lid body 36.

A second cooling flow passage 52 is provided between the second exterior body side 32 and the second electrode laminate body side 44. Specifically, the second cooling flow passage 52 is a portion surrounded by the second exterior body side 32, the second electrode laminate body side 44, the side wall 35, and the lid body 36.

As shown in FIG. 2, in plan view, a first width H1 from the first exterior body side 31 to the first electrode laminate body side 43 is narrower than a second width H2 from the second exterior body side 32 to the second electrode laminate body side 44. As shown in FIG. 3 to FIG. 4, since a third width H3 from the side wall 35 to the lid body 36 is uniform, a cross-sectional area of a D2-D3 cross-section of the first cooling flow passage 51 is smaller than a cross-sectional area of a D1-D3 cross-section of the second cooling flow passage 52.

A region where the first cooling flow passage 51 and the second cooling flow passage 52 cross with each other includes a third cooling flow passage 53. The third cooling flow passage 53 is located at the outside of four corners of the electrode laminate body 4.

The connection port 7 includes a first connection port 71 and a second connection port 72. The first connection port 71 and the second connection port 72 are provided on the first exterior body side 31. The first connection port 71 and the second connection port 72 are provided on the first exterior body side 31 at each position corresponding to the third cooling flow passage 53. Each of the first connection port 71 and the second connection port 72 communicates with the third cooling flow passage 53.

The exterior terminal 11 protrudes from the second exterior body side 32. The external terminal 11 includes a positive electrode terminal 12 and a negative electrode terminal 13.

As shown in FIG. 1, the cooling structure 100 of the secondary battery 1 includes a plurality of secondary batteries 1.

The plurality of secondary batteries 1 are arranged side-by-side. The positive terminal 12 of the secondary battery 1 is electrically connected to the negative terminal 13 of the adjacent secondary battery 1 by the internal bus bar 14.

The internal bus bar 14 is connected to the resin film 42 (resin film peripheral portion 42B). The positive terminal 12 and the negative terminal 13 of the secondary battery 1 are electrically connected to an external device (not shown) by a harness (not shown). The fluid is filled in a space around the internal bus bar 14.

In the present embodiment, the positive terminal 12 is made, for example, of an aluminum alloy. Therefore, the positive terminal 12 has excellent thermal conductivity. In the present embodiment, the negative terminal 13 is made, for example, of a copper alloy. Therefore, the negative terminal 13 has excellent thermal conductivity.

The plurality of secondary batteries 1 included in the power storage module pack 20 are connected to each other by a refrigerant flow path 21. The plurality of secondary batteries 1 (unit cells) may be a structure hermetically sealed by a metal mold packaging material (not shown); however, the structure of the power storage module pack 20 is not particularly limited.

### Operation and Effect of Cooling Structure 100 of Secondary Battery

Hereinafter, an operation of the cooling structure 100 of the secondary battery 1 is described.

When the secondary battery 1 starts charging and discharging, the secondary battery 1 is heated to a high temperature, and a gas is generated from the electrode body 41. The generated gas passes through the resin film 42 and flows into a space provided between the resin film 42 and the exterior body 3.

When the pump P of the circulation circuit 10 is driven, the fluid flows to the secondary battery 1 at a high temperature toward the first connection port 71 of the secondary battery 1. The fluid flows from the third cooling flow passage 53 to the first cooling flow passage 51 and the second cooling flow passage 52. The flow amount of the fluid that flows into the first cooling flow passage 51 and the second cooling flow passage 52 is a constant amount and the same amount. Since the cross-sectional area of the D2-D3 cross-section of the first cooling flow passage 51 is smaller than the cross-sectional area of the D1-D3 cross-section of the second cooling flow passage 52, the flow speed v1 of the fluid that flows through the first cooling flow passage 51 is faster than the flow speed v2 of the fluid that flows through the second cooling flow passage 52.

By performing the heat exchange between the secondary battery 1 and the fluid, the secondary battery 1 is cooled. The fluid in the secondary battery 1 is discharged from the second connection port 72 to the gas-liquid separation tank ST.

Hereinafter, the effect of the cooling structure 100 of the secondary battery 1 is described.

In the configuration of the present embodiment, the fluid flows through the space between the exterior body 3 and the electrode laminate body 4. Therefore, it is possible to provide the cooling structure 100 of the secondary battery 1 capable of quickly cooling the secondary battery 1 while sufficiently removing the gas generated in the inside of the secondary battery 1.

In the configuration of the present embodiment, the cross-sectional area of the D2-D3 cross-section of the first cooling flow passage 51 is smaller than the cross-sectional area of the D1-D3 cross-section of the second cooling flow passage 52. Therefore, by increasing the flow speed v1 of the fluid that flows through the first cooling flow passage 51 and decreasing the flow speed v2 of the fluid that flows through the second cooling flow passage 52, it is possible to enhance the discharge property of the gas generated in the fluid while equalizing the flow amount distribution of the fluid.

In the configuration of the present embodiment, each of the first connection port 71 and the second connection port 72 is provided in a region (the third cooling flow passage 53) where the first cooling flow passage 51 and the second cooling flow passage 52 cross with each other and communicates with the third cooling flow passage 53. Therefore, it is possible to further efficiently remove the gas remaining in the region (the third cooling flow passage 53) where the first cooling flow passage 51 and the second cooling flow passage 52 cross with each other by using the flow speed v1 of the fluid that flows through the first cooling flow passage 51.

### Second Embodiment

Hereinafter, a second embodiment is described. The difference between the first embodiment and the second embodiment is the position where the first connection port 71 and the second connection port 72 are provided.

In the cooling structure 100 of the secondary battery 1 according to the second embodiment, the first connection port 71 and the second connection port 72 are provided at a position that overlaps the first cooling flow passage 51. The first connection port 71 and the second connection port 72 communicate with the first cooling flow passage 51.

In the configuration of the second embodiment, it is possible to further increase the flow speed v1 of the fluid that flows through the first cooling flow passage 51. Therefore, it is possible to further efficiently remove the gas remaining in the region (the third cooling flow passage 53) where the first cooling flow passage 51 and the second cooling flow passage 52 cross with each other by using the flow speed v1 of the fluid that flows through the first cooling flow passage 51.

### Modified Example

The present embodiment is described using a configuration in which the first connection port 71 and the second connection port 72 are provided on only one of the pair of first exterior body sides 31; however, the embodiment is not limited thereto. The first connection port 71 and the second connection port 72 may be provided on each of the pair of first exterior body sides 31. Specifically, the first connection port 71 may be provided on one of the pair of exterior body sides 31, and the second connection port 72 may be provided on the other of the pair of first exterior body sides 31.

Although the preferred embodiments of the present invention have been described, the present invention is not limited thereto. Additions, omissions, substitutions, and other modifications of the configuration can be made without departing from the scope of the present invention, and the modified example described above can be suitably combined.

What is claimed is:

1. A secondary battery cooling structure, comprising:
a circulation circuit that circulates a fluid;
an exterior body having a connection port that communicates with the circulation circuit; and
an electrode laminate body having a flat plate shape, accommodated in the exterior body, and formed to be sealed by a resin film,
wherein the exterior body and the electrode laminate body are provided to be spaced apart from each other, and
the fluid flows through a space between the exterior body and the electrode laminate body.

2. The secondary battery cooling structure according to claim 1,
wherein the connection port includes a first connection port and a second connection port,
the exterior body has a substantially square shape in plan view formed of a pair of first exterior body sides and a pair of second exterior body sides orthogonal to the first exterior body sides,
the first connection port and the second connection port are provided on the first exterior body sides,
the electrode laminate body is formed of a first electrode laminate body side that faces the pair of first exterior body sides and a second electrode laminate body side that faces the pair of second exterior body sides in plan view, and have a substantially square shape that is smaller than the exterior body,
a first cooling flow passage is provided between the first exterior body side and the first electrode laminate body side,
a second cooling flow passage is provided between the second exterior body side and the second electrode laminate body side, and
a cross-sectional area of the first cooling flow passage is smaller than a cross-sectional area of the second cooling flow passage.

3. The secondary battery cooling structure according to claim 2,
wherein each of the first connection port and the second connection port is provided in a region where the first cooling flow passage and the second cooling flow passage cross with each other.

4. The secondary battery cooling structure according to claim 2,
wherein the first connection port and the second connection port are provided at a position that overlaps the first cooling flow passage.
